(19) United States
(12) Patent Application Publication
(10) Pub. No.: US 2009/0222911 A1
(43) Pub. Date: Sep. 3, 2009

(54) MULTI-USER LOGIN METHOD FOR COMPUTER NUMERICAL CONTROL MACHINE

(75) Inventors: YUE-WEN CHEN, Tu-Cheng (TW); FEI-HSU CHEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: FOXNUM TECHNOLOGY CO., LTD., Tucheng City (TW)

(21) Appl. No.: 12/100,381

(22) Filed: Apr. 9, 2008

(30) Foreign Application Priority Data
Mar. 3, 2008 (CN) 200810300450.7

(51) Int. Cl. H04L 9/32

(52) U.S. Cl. 726/19

(57) ABSTRACT

An exemplary multi-user login method for a computer numerical control (CNC) machine includes: initializing a program installed in the CNC machine, thereby displaying a user selection interface on a screen of the CNC machine; a user inputting a user name and password on the user selection interface; the program of the CNC machine determining whether or not the user is registered based on the user name and password entered; if the user is registered, an operating system of the CNC machine loading a driver program installed in a motion control card of the CNC machine, and the driver program reading the user's personal information stored in the motion control card; and accessing a user operation interface of the registered user.

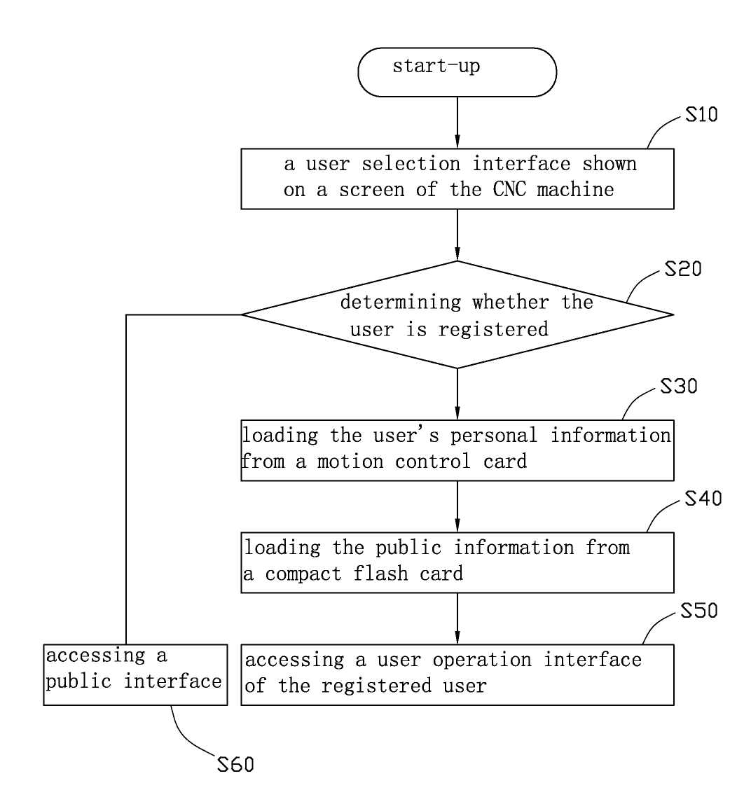

### BACKGROUND

1. Field of the Invention

The present invention relates to a multi-user login method for a computer numerical control (CNC) machine.

2. Description of Related Art

A CNC machine is commonly used in modern companies nowadays. A program installed in the CNC machine can decode control codes to control machining parts. Different users may login to the CNC machine to access their preference interface. In particular, user-specific information often includes personal information, business information, and/or identification information for accessing a network or online service that requires user authentication. Furthermore, since several different users share one CNC machine, it is important to take measures in protecting data in the CNC machine. More specifically, it is important to permit only authorized users to start and use the CNC machine.

What is needed, therefore, is a multi-user login method for a CNC machine that can solve the problem mentioned above.

### SUMMARY

An exemplary multi-user login method for a computer numerical control (CNC) machine includes: initializing a program installed in the CNC machine, thereby displaying a user selection interface on a screen of the CNC machine; a user inputting a user name and password on the user selection interface; the program of the CNC machine determining whether or not the user is registered based on the user name and password entered; if the user is registered, an operating system of the CNC machine loads a driver program installed in a motion control card of the CNC machine, and the driver program reads the user's personal information stored in the motion control card; and accessing a user operation interface of the registered user.

Other advantages and novel features of the present invention will become more apparent from the following detailed description of preferred embodiment when taken in conjunction with the accompanying drawing, in which:

### BRIEF DESCRIPTION OF THE DRAWINGS

The flow chart represents a multi-user login method for a computer numerical control machine according to an embodiment of the present invention.

### DETAILED DESCRIPTION

The flow chart shows a multi-user login method for a CNC machine in accordance with an embodiment of the present invention for allowing different users to login via a program installed in the CNC machine, thereby displaying an interface with his/her user-specific preferences. User-specific information includes user's personal information, whereas public information is stored in the program's memory. User's personal information includes a user name, user password, password hints, window language type settings, and personal preference settings, etc. The user's personal information is stored in a nonvolatile memory of a motion control card mounted on the CNC machine, public information is stored in a Compact Flash (CF) card mounted on the CNC machine, and the format for storing public information is Extensible Markup Language (XML).

Referring to the flow chart, the multi-user login method includes:

step S10, initializing the program, thereby displaying a user selection interface on a screen of the CNC machine;

step S20, a user inputting a user name and password on the user selection interface, the program of the CNC machine determining whether or not the user is registered based on the user name and password entered. If the user name and password are consistent with the user name and password stored in the motion control card, the user is registered and the program implements step S30. Otherwise, the user is not registered, the program implements step S60, and the user is given access to a public interface with public information;

step S30, an operating system of the CNC machine loading a driver program installed in the motion control card, and the driver program reading the user's personal information stored in the motion control card;

step S40, the program of the CNC machine loading public information stored in an expansion memory mounted on the CNC machine into a memory; and

step S50, accessing a user operation interface of the registered user.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A multi-user login method for a computer numerical control (CNC) machine comprising:
initializing a program installed in the CNC machine, thereby displaying a user selection interface on a screen of the CNC machine;
a user inputting a user name and password on the user selection interface; the program of the CNC machine determining whether or not the user is registered based on the user name and password entered;
if the user is registered, an operating system of the CNC machine loading a driver program installed in a motion control card of the CNC machine, and the driver program reading the user's personal information stored in the motion control card; and
accessing a user operation interface of the registered user.

2. The multi-user login method as claimed in claim 1, further comprising: the program of the CNC machine loading public information stored in an expansion memory into a memory.

3. The multi-user login method as claimed in claim 2, further comprising: if the user is not registered, the user is given access to a public interface with public information.

4. The multi-user login method as claimed in claim 2, wherein the format for the public information stored in the expansion memory mounted in the CNC machine is extensible markup language.

5. The multi-user login method as claimed in claim 2, wherein the expansion memory is a compact flash card.

6. The multi-user login method as claimed in claim 1, wherein the user personal information includes user name, user password, password hints, window language type settings and user personal preference settings.
